(19) United States
(12) Patent Application Publication
(10) Pub. No.: US 2002/0038438 A1
(43) Pub. Date: Mar. 28, 2002

(54) Information processing unit with failure information management function and failure information management method four

(75) Inventor: Toshinobu Kikuchi, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/962,324

(22) Filed: Sep. 26, 2001

(30) Foreign Application Priority Data
Sep. 27, 2000 (JP) 2000-294183

(51) Int. Cl. H04L 1/22

(52) U.S. Cl. 714/25

(57) ABSTRACT

When a PWB is returned to the unit producing factory, the history of the past failure information can be grasped with reliability. An information processing unit with a failure information management function under a host unit to send/receive information to/from the host unit and having a plurality of PWBs, includes: the PWBs each provided with rewritable ROM; wherein at least one of the PWBs has a CPU for controlling sending/receiving of information to/from the host unit and input/output of information of the rewritable ROM; the rewritable ROM stores the identification code and the failure information of the PWB.

### BACKGROUND OF THE INVENTION

1. Field of the Invention

The present invention relates to an information processing unit with a failure information management function and a failure information management method of the information processing unit, more specifically, to failure information management and maintenance for printed wired boards (hereinafter, referred to as PWBs).

2. Description of Related Art

In a related art information processing unit constructed by a plurality of processors and a plurality of printed wired boards (hereinafter, referred to as PWBs), a host unit collects a failure spot, a failure date and a cause as failure information in the event a failure occurs. PWB in this specification is a printed wired board with necessary parts such as electronic parts, mechanical parts and connectors mounted thereon and all the processes such as soldering and coating are completed. When a PWB is replaced for failure repairs, the host unit can grasp information on what kind of PWB is replaced.

Japanese Published Unexamined Patent Application No. Hei 2-245838 discloses that information on which one of the same kind of PWBs produced previously is replaced (such as a serial number), failure data and failure time are collected; the information is accumulated from a service assistance device through a line to a remote maintenance center; and a past failure history is managed for each of the PWBs, which are used for user maintenance. The failure history for each of the PWBs is fetched so as to be a judging material for reuse/reproduction. It is thus possible to grasp, to some extent, information on what history the PWB currently mounted has before being mounted onto the information processing unit (a new PWB is not always mounted).

In the case that the remote maintenance center manages the history for each of the PWBs, the failure histories of all the PWBs cannot be always grasped. For example, in the case that some users use the unit without being connected to the maintenance center through a line or that the line cannot be connected temporality, the failure information of the PWB replaced here is not be accumulated. When such a PWB is returned to the unit producing factory, the maintenance center cannot grasp the history of the failure information.

When a PWB includes consumable parts (such as batteries), the parts must be replaced periodically or corresponding to an operating experience thereof. When a PWB is replaced for failure repairs, in consideration of the fact that the PWB is replaced, information on when the consumable parts need replacing must be managed. The host unit cannot grasp these managements, so that the unit manager must manually manage the information.

In the first problem, in the case that the above-mentioned maintenance center manages the history for each of PWBs, the history of failure information can not be grasped when the PWB is returned to the unit producing factory. The reason is that there is a case that some users use the unit without being connected to the maintenance center through a line or that the line cannot be connected temporarily.

In the second problem, when the PWB includes consumable parts having a limited life, the maintenance quality may be varied.

When the PWB includes the consumable parts, the host unit cannot grasp these, so that the maintenance manager manually manages the PWB including a plurality of parts. The replacement time cannot be managed sufficiently.

### SUMMARY OF THE INVENTION

An object of the present invention is to enhance maintain ability by writing into each PWB itself an identification code, a producing date, and other failure information so that a processor in the PWB or a processor managing the PWB can read them, adding information such as an identification code or a producing date to the failure information, and reporting the elapsed time for replacement of consumable parts to a host unit, thereby notifying the user the time required to maintain the PWB.

The failure information is used during repairing of a PWB, thereby increasing the failure relapse. The number of unrepairable products is reduced to enhance the reusability of the PWB.

An information processing unit with a failure information management function according to the present invention under a host unit to send/receive information to/from the host unit and having PWBs, includes:

the PWBs each provided with a rewritable ROM;

wherein at least one of the PWBs has a CPU for controlling sending/receiving of information to/from the host unit and input/output of information of the rewritable ROM;

the rewritable ROM stores the identification code and the failure information of the PWB.

In the information processing unit with a failure information management function according to the present invention, the rewritable ROM is a flash ROM.

In the information processing unit with a failure information management function according to the present invention, the failure information includes a PWB producing date, the parts names of parts in the PWB to be revision managed, and revision numbers thereof.

In the information processing unit with a failure information management function according to the present invention, the failure information includes the failure spot, the failure contents, and the failure date of the PWB.

In the information processing unit with a failure information management function according to the present invention, the CPU judges from the PWB producing date whether the time to replace the PWB has come or not.

In the information processing unit with a failure information management function according to the present invention, the failure information is reported to the host unit so that the host unit can clarify the failure information.

A failure information management method according to the present invention of an information processing unit under a host unit to send/receive information to/from the host unit and having PWBs, includes the steps of:

reading a PWB identification code and the last replacement date of consumable part from a rewritable ROM in a PWB;

judging from the replacement date of the consumable part whether the consumable part is consumed or not; and

notifying to the host unit the PWB identification code and the part name in order to have the consumable part replaced by the maintenance manager when judging that the part is consumed.

A failure information management method according to the present invention of an information processing unit under a host unit to send/receive information to/from the host unit and having PWBs, includes the steps of:

reading a PWB identification code and the last replacement date of consumable parts from a rewritable ROM in a PWB;

calculating an elapsed time A from the last part replacement date to the present date;

reading a replacement interval B determined for each of consumable parts;

in order to have the consumable part replaced by the maintenance manager when A<B, notifying and displaying the PWB identification code and the part name to the host unit; and

updating information of the replacement date after replacement operation.

The failure information can be thus corresponded with the PWB so as to easily find the past history of the PWB. The part to be repaired and the relapse test can be easily specified. The degree of completion of the repair can be increased. The processor (CPU or central processor unit) can manage the consumable parts without the manual management performed by the maintenance manager. The maintainability can be thus enhanced.

### BRIEF DESCRIPTION OF THE DRAWINGS

The novel features believed characteristic of the invention are set forth in the appended claims. The invention itself, however, as well as other features and advantages thereof, will be best understood by reference to the detailed description which follows, read in conjunction with the accompanying drawings, wherein:

FIG. 1 is a block diagram of the entire information processing unit of the present invention;

FIG. 2 is a block diagram of PWBs of the information processing unit of the present invention;

FIG. 3 is an inner use view of a flash ROM of the present invention;

FIG. 4 is a block diagram of a table stored in a management bank of the present invention; and

FIG. 5 is a flowchart showing a method for managing consumable parts of the present invention.

### DESCRIPTION OF THE PREFERRED EMBODIMENTS

A first embodiment of the present invention will be described hereinbelow in detail.

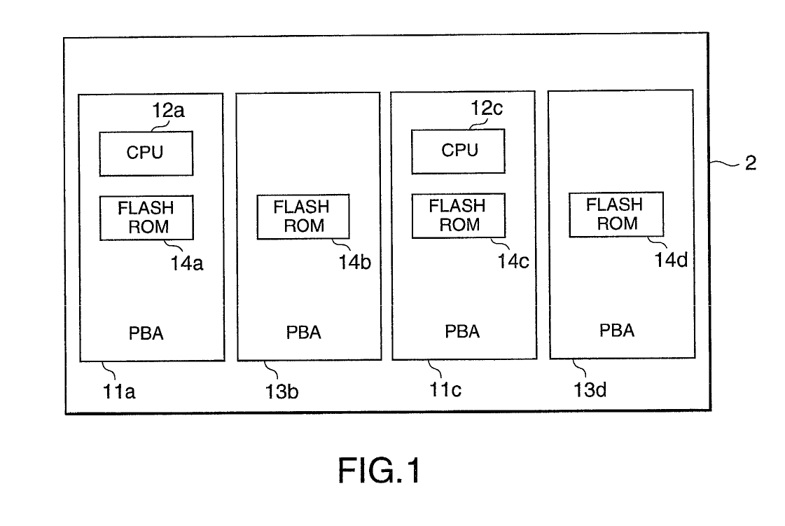

Referring to FIG. 1, in the embodiment of the present invention, an information processing unit 2 with a failure information management function includes a plurality of PWBs 11a, 11b, 11c and 11d. A flash ROM (which stands for Flash Read Only Memory, is also called a flash memory, and means a rewritable ROM capable of electrically erasing stored data) is mounted onto each of all the PWBs. Here, flash ROMs 14a, 14b, 14c and 14d are respectively mounted onto the PWBs 11a, 11b, 11c and 11d. CPUs 12a and 12c are respectively mounted onto the PWBs 11a and 11c. No CPU is mounted onto PWBs 13b and 13d. There are mixed the PWBs mounting the CPU and the PWBs not mounting the CPU. At least one PWB mounting the CPU must be in the information processing unit 2.

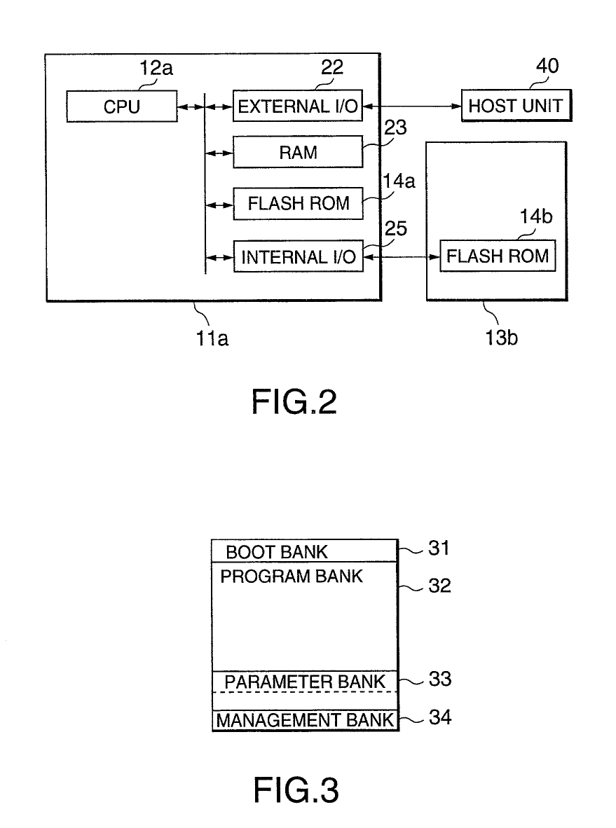

The flash ROMs 14b and 14d each including an identification code and producing date information are mounted not only onto the PWBs with the CPU but also onto the PWBs 13b and 13d not with the CPU. Regardless of whether the CPU is present or not, the identification codes are added to all the PWBs and the producing dates are written thereinto. Referring to FIG. 2, the PWB 11a having the CPU has the CPU 12a for controlling the operation of the PWB 11a and the PWB 11b not having the flash ROM, an external I/O 22 connected to a host unit 40 for reporting a failure, an RAM 23 for holding a program being executed, the flash ROM 14a for adding an identification code and storing a producing date, and an internal I/O 25 for controlling other PWB. The flash ROM 14b is mounted onto the other PWB. The information processing unit 2 is under the host unit 40 (for example, corresponding to a host computer) and sends/receives information to/from the host unit. The information processing unit 2 corresponds to, for example, a magnetic disk apparatus, a magnetic tape unit, an optical disk drive, a printer, other peripheral devices, and a controller for controlling the peripheral devices.

Referring to FIG. 3, the information processing unit of the present invention uses a 16 Mbyte flash ROM having an 8-Bit width and 32 banks (the flash ROM is typically divided into a plurality of banks and permits erasing for each of the banks). There are four kinds of banks of a boot bank 31 for storing a boot program used when the CPU is booted up, a program bank 32 for storing a program for having control over the operation of the CPU, a parameter bank 33 for storing control parameters indicating the setting information of the unit, and a management bank 34 for storing failure information. One flash ROM has at least four regions having a single kind of bank.

The operation of the embodiment of the present invention will be described hereinbelow.

The boot bank 31 stores a boot program used when the CPU 12a is booted up. Only the boot program is written into the boot bank 31 before the flash ROM is mounted onto the PWB (11a), and then, the flash ROM is mounted onto the PWB. Nothing is not written in this bank after the mounting.

The boot program copies a program in the program bank 32 from the flash ROM 14a to the RAM 23 for execution when the information processing unit 2 is booted up. An error detection code is checked during the copying. When there is no abnormality, normal operation can be ensured.

Without using the program stored in the program bank, the downloading operation from the host unit 40 is executed to obtain another program. This can execute a latest revision program in the field. When both the host unit 40 and the information processing unit 2 are booted up, the contents of the program bank 32 are erased. A program transferred from the host unit 40 by downloading is written thereinto. The program transferred by downloading upon the next booting-up is copied from the flash ROM 14a to the RAM 23 for execution.

The control parameters indicating the setting information of the unit (such as IP address, physical address, and the next information used when the power is turned off) and used for controlling the unit are stored in the parameter bank 33. To prevent the parameters from being lost during rewriting due to a failure, two banks are allocated into the parameter bank 33 so as to be doubled. The doubling is performed in a manner such that erasing and writing are done for each of the banks to confirm after the completion of updating of one of the banks that the parameter is written normally, and then, the other bank is updated. The parameter bank 33 can be rewritten by an instruction from the host unit 40 to meet the user demand after shipping.

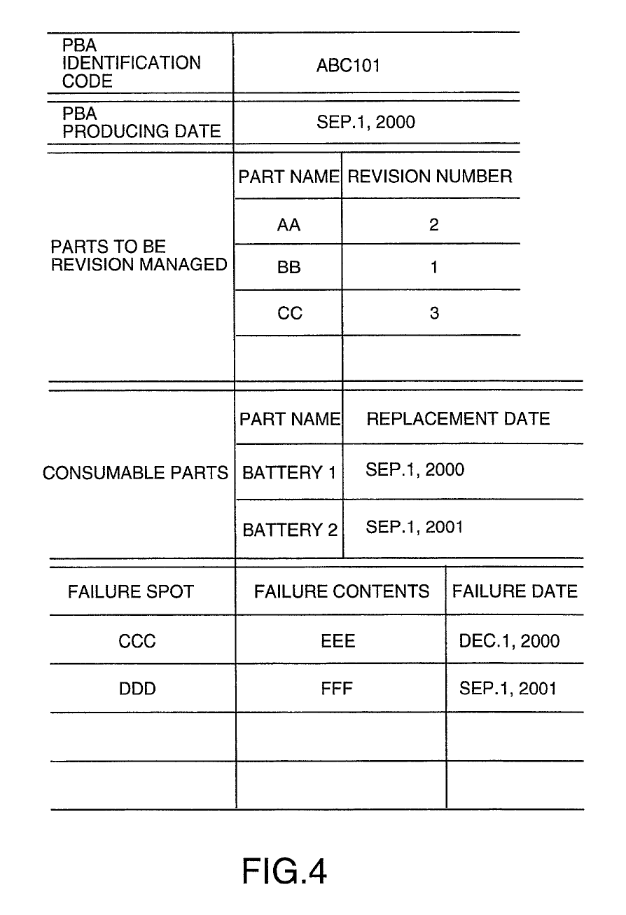

FIG. 4 shows one example of a block diagram of a table stored in the management bank 34. A method for using the management bank 34 is different from that of the above-mentioned bank. The management bank 34 is mounted in an erased state. After the completion of mounting, the power is turned on, only one writing processing is performed by an instruction from dedicated producing equipment, not shown, connected to the external I/O 22. Then, a PWB identification code (corresponding to a serial number) indicating what PWB is used, a PWB producing date, names of parts mounted onto the PWB, and a revision thereof for each of the parts are written for shipping. In particular, chips for storing the control program, circuit, and hard logic manage the revisions. These are useful as reference information for analyzing a failure of the PWB.

The parts are mounted mechanically. It is difficult to write the different contents into a plurality of ROMs at the same time before mounting. Therefore, these codes are not written into the flash ROMs before mounting. The writing is in principle performed only in the factory after the parts are mounted onto the PWB. The different contents are written into each of the ROMs, because writing in a state that the parts are mounted is at low cost.

Into the management bank 34, the part name of the consumable part (e.g., a battery 1) and a replacement date as the replacement time thereof are written in order that when a predetermined time elapses from the replacement time the host unit detects it to notify it to the user. The item may be written not only in the factory before shipping but also in the field after shipping so that the part can be replaced in the field.

Further, into the management bank 34, the failure spot, the failure contents, the failure date, and the like are written when specified in the PWB 11a. The failure spot and the failure contents can be easily specified by abnormal detection means using a known technique such as parity check or CRC check. The failure contents include, for example, reporting of input data abnormality, output data abnormality, and abnormal termination during writing. The failure contents can be added sequentially to the item in the field after shipping. The item serves as a log of the past failure information.

Generally, when the unit of the present invention detects a failure is caused in the PWB 11a on which the CPU 12a is mounted, control of the CPU 12a allows accumulated failure information with the identification code of the flash ROM 14a added thereto to be transferred as a log through the external I/O 22 to the host unit 40. When the abnormal detection means described later detects that another PWB 13b under control of the CPU 12a is failed, the failure information with the identification code of the flash ROM 14b added thereto is transferred through an internal I/O 25 and the external I/O 22 to the host unit 40. These logs are transferred as the logs including the past failure information each time a failure is caused.

The contents of the log include the failure spot, the failure contents, the failure causes, and the failure date. The failure spot, the failure contents, and the failure cause can be easily specified by the abnormal detection means, not shown, present in the information processing unit using a known technique such as parity check or CRC check. The failure contents include reporting of input data abnormality, output data abnormality, and abnormal termination during writing.

When a failure does not occur and a predetermined period elapses from the PWB producing date of the PWBs 11a and 13b, it is judged that the PWBs 11a and 13b have run down or are consumed to replace the PWBs. It is possible to avoid a failure caused by continued use of the consumed PWB.

Since the host unit 40 is connected to a management center by a communication line, logs are sent from the host unit 40 to the management center. The logs are managed together in the management center. A PWB is replaced at the site (or in the factory) The PWB removed by replacement is sent to the repair center. The log into which the detailed failure contents managed together in the management center are written and the identification code of the replaced PWB are managed in a unified way. In this way, there pair efficiency of the failed PWB can be increased to enhance the maintainability of the unit. In this case, when there is no log sent to the management center, the failure information described above is stored in the PWB itself. This is read in the repair center to increase the repair efficiency of the failed PWB.

The CPU in the PWB monitors the producing date and the present time, and then, reports the replacement time of a battery as the consumable part needed to be replaced periodically. The unit itself can manage the PWB without troubling the unit manager, thereby enhancing the maintainability.

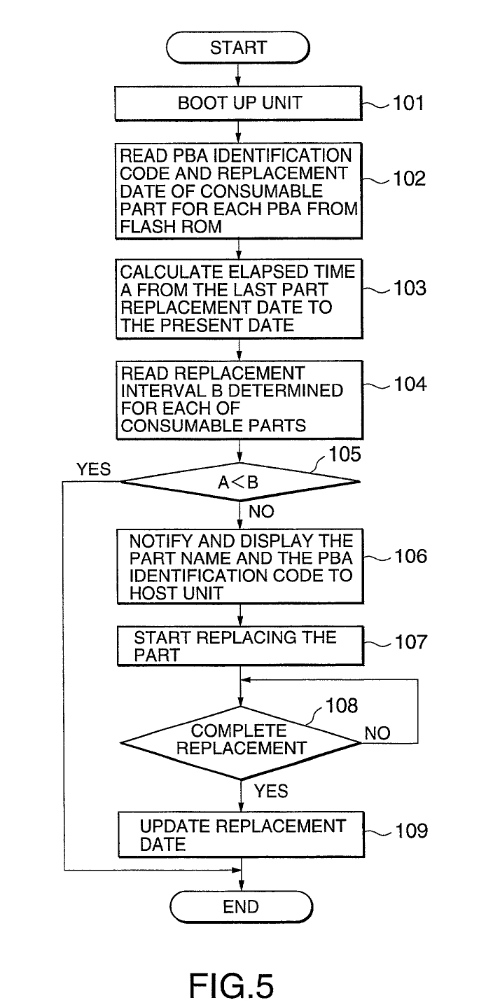

Referring to FIG. 5, one example of a method for managing a consumable part will be described. When the information processing unit 2 with a failure information management function is booted up (step 101), the CPU 12a reads a PWB identification code and the last replacement date of a consumable part (a PWB producing date when the consumable part has not been replaced) from the management bank 34 of the flash ROM 14a (step 102) so as to calculate an elapsed time A from the last part replacement date to the present date (step 103).

On the other hand, a replacement interval B determined for each of the consumable parts is read from a region, not shown, of the management bank 34 (step 104) so as to judge whether A is smaller than B (step 105). When A is smaller than B, the consumable part does not have to be replaced. The routine is terminated to move to the original operation of the unit. When A is not smaller than B, the PWB identification code and the part name are notified to the host unit 40 so as to be displayed by display means, not shown (step 106). The part is replaced manually (step 107). When the replacement is completed (step 108), the present date is written into the replacement date column in the management bank 34 to update the replacement date column (step 109). The above-mentioned processing is done for all the consumable parts. The CPU 12a reads information from the management bank 34 of the flash ROM 14b to perform the same processing to another PWB 13b thereunder.

There is described the present invention when the flash ROMs are mounted onto all the PWBs. It is also possible to consider a structure such that the flash ROMs are respectively mounted onto some PWBs, and the failure information management of the present invention is performed to only the PWBs each mounting the flash ROM. In this case, needless to say, the PWBs each mounting the flash ROM can provide the same operation and effect as in the present invention.

In a first effect of the present invention, in the case that the above-mentioned maintenance center manages the history for each of PWBs, the history of failure information can be grasped when the PWB is returned to the unit producing factory. Even if there may be a case that some users use the unit without being connected to the maintenance center through a line or that the line cannot be connected temporarily, the PWB itself is sure to hold the failure information so as to easily find what PWB is used.

In a second effect, when a PWB includes consumable parts having a limited life, the maintenance equality will not be varied.

When the PWB includes the consumable parts, the host unit can recognize that these consumable parts needs repairing. Even when the maintenance manager does not manages the PWB including a plurality of parts, the replacement time can be grasped sufficiently.

Further, the identification code, the producing date, and other failure information are written into each PWB itself so that a processor can read them.

The failure information is used during repairing of a PWB, thereby increasing the failure relapse. The number of unrepairable products is reduced to enhance the reusability of the PWB.

While this invention has been described with reference to illustrative embodiments, this description is not intended to be construed in a limiting sense. Various modifications of the illustrative embodiments as well as other embodiments of the invention, will be apparent to persons skilled in the art upon reference to this description. It is, therefore, contemplated that the appended claims will cover any such modifications or embodiments as fall within the true scope of the invention.

What is claimed is:

1. An information processing unit with a failure information management function under a host unit to send/receive information to/from the host unit and having PWBs, comprising:
said PWBs each provided with a rewritable ROM;
wherein at least one of said PWBs has a CPU for controlling sending/receiving of information to/from said host unit and input/output of information of said rewritable ROM;
said rewritable ROM stores the identification code and the failure information of the PWB.

2. The information processing unit with a failure information management function according to claim 1, wherein said rewritable ROM is a flash ROM.

3. The information processing unit with a failure information management function according to claim 1, wherein said failure information includes a PWB producing date, the parts names of parts in said PWB to be revision managed, and revision numbers thereof.

4. The information processing unit with a failure information management function according to claim 2, wherein said failure information includes a PWB producing date, the parts names of parts in said PWB to be revision managed, and revision numbers thereof.

5. The information processing unit with a failure information management function according to claim 1, wherein said failure information includes the failure spot, the failure contents, and the failure date of said PWB.

6. The information processing unit with a failure information management function according to claim 2, wherein said failure information includes the failure spot, the failure contents, and the failure date of said PWB.

7. The information processing unit with a failure information management function according to claim 3, wherein said failure information includes the failure spot, the failure contents, and the failure date of said PWB.

8. The information processing unit with a failure information management function according to claim 4, wherein said failure information includes the failure spot, the failure contents, and the failure date of said PWB.

9. The information processing unit with a failure information management function according to claim 3, wherein said CPU judges from said PWB producing date whether the time to replace the PWB has come or not.

10. The information processing unit with a failure information management function according to claim 1, wherein said failure information is reported to said host unit so that said host unit can clarify said failure information.

11. The information processing unit with a failure information management function according to claim 2, wherein said failure information is reported to said host unit so that said host unit can clarify said failure information.

12. A failure information management method of an information processing unit under a host unit to send/receive information to/from the host unit and having PWBs, comprising the steps of:
reading a PWB identification code and the last replacement date of consumable part from a rewritable ROM in a PWB;
judging from the replacement date of said consumable part whether said consumable part is consumed or not; and
notifying to the host unit the PWB identification code and the part name in order to have the consumable part replaced by the maintenance manager when judging that said part is consumed.

13. A failure information management method of an information processing unit under a host unit to send/receive information to/from the host unit and having PWBs, comprising the steps of:
reading a PWB identification code and the last replacement date of consumable parts from a rewritable ROM in a PWB;
calculating an elapsed time A from the last part replacement date to the present date;
reading a replacement interval B determined for each of consumable parts;
in order to have the consumable part replaced by the maintenance manager when A<B, notifying and displaying the PWB identification code and the part name to the host unit; and
updating information of said replacement date after replacement operation.
